(19) United States
(12) Patent Application Publication
(10) Pub. No.: US 2010/0201772 A1
(43) Pub. Date: Aug. 12, 2010

(54) PRINTING METHOD

(75) Inventor: Toyohiko Mitsuzawa, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/703,708

(22) Filed: Feb. 10, 2010

(30) Foreign Application Priority Data
Feb. 12, 2009 (JP) 2009-030321

(51) Int. Cl. B41J 2/01

(52) U.S. Cl. 347/102

(57) ABSTRACT

Provided is a printing method of printing a color image on a medium using a printing apparatus. The method includes forming dots on a medium by using cyan ink, magenta ink, and yellow ink that are cured when irradiated with electromagnetic waves, and then forming dots on the medium by using at least any ink among red ink, green ink, blue ink, and orange ink cured when irradiated with electromagnetic waves.

### BACKGROUND

1. Technical Field

The present invention relates to a printing method.

2. Related Art

A printing apparatus is known that performs printing by using ink (for example, UV ink) cured when irradiated with electromagnetic waves (for example, ultraviolet ray (UV light)). In such a printing apparatus, after ink is discharged onto a medium (such as paper, film or the like) from a nozzle, dots formed in the medium are irradiated with electromagnetic waves. Since the dots are cured and adhere to the medium with the above operation, printing can be favorably performed even on a medium that does not easily absorb ink (for example, please refer to JP-A-2000-158793).

A printing apparatus (for example, a printer) expresses each color of a color image through the combined use of cyan, magenta, and yellow ink.

In the printing apparatus as described above, UV ink is used so that printing can be performed even on a medium that has low absorbability. However, when the UV ink is used together in printing, there is a problem that the color the user wants to express does not appear well (color development is bad) as will be described below.

Therefore, the invention aims to improve the color development.

### SUMMARY

An advantage of some aspects of the invention is that it provides a printing method of printing a color image on a medium using a printing apparatus, after dots are formed on a medium by using cyan ink, magenta ink, and yellow ink cured when irradiated with electromagnetic waves, dots are formed on the medium by using at least any ink among red ink, green ink, blue ink, and orange ink cured when irradiated with electromagnetic waves.

Other characteristics of the invention will be clarified by the description of the present specification and accompanying drawings.

### BRIEF DESCRIPTION OF THE DRAWINGS

The invention will be described with reference to the accompanying drawings, wherein like numbers reference like elements.

FIG. 1 is a block diagram illustrating the entire configuration of a printer.

FIG. 2 is a schematic diagram illustrating the surroundings of a printing region.

FIG. 3 is an explanatory diagram illustrating the arrangement of nozzles in each head for color ink.

FIG. 4 is a flowchart illustrating a process performed by a printer driver during printing.

FIG. 5 is a flowchart illustrating a printing process of a printer according to an embodiment.

FIG. 6A is a schematic diagram illustrating a configuration of the surroundings of a printing region according to a second embodiment, and FIG. 6B is a diagram when FIG. 6A is viewed from a side.

FIGS. 7A to 7C are diagrams for explaining the arrangement of nozzles in each head and the formation of dots.

FIGS. 8A to 8I are diagrams illustrating the appearance of the formation of dots according to the second embodiment.

### DESCRIPTION OF EXEMPLARY EMBODIMENTS

Based on the present specification and accompanying drawings, at least the following matters are apparent.

According to an aspect of the invention, there is provided a printing method of printing a color image on a medium using a printing apparatus. The printing method includes forming dots on a medium by using cyan ink, magenta ink, and yellow ink cured when irradiated with electromagnetic waves, and then forming dots on the medium by using at least any ink among red ink, green ink, blue ink, and orange ink cured when irradiated with electromagnetic waves.

With the printing method, it is possible to improve the color development of specific colors (for example, green).

According to the above aspect of the invention, there is provided the printing method, in which the dots formed with the cyan ink, the magenta ink, and the yellow ink are irradiated with the electromagnetic waves after forming the dots on the medium by using the cyan ink, the magenta ink, and the yellow ink, and before forming the dots on the medium by using at least any ink among the red ink, the green ink, the blue ink, and the orange ink.

With the printing method, it is possible to suppress the spreading of ink, and thereby to further improve the saturation.

According to the above aspect of the invention, there is provided the printing method that further includes forming dots on the medium at a first interval in a predetermined direction by discharging at least any predetermined ink among the red ink, the green ink, the blue ink, and the orange ink on the medium, irradiating the dots formed on the medium with electromagnetic waves, forming dots on the medium at the first interval in the predetermined direction with the predetermined ink so that the dots irradiated with electromagnetic waves and the dots not irradiated with electromagnetic waves are positioned in the predetermined direction at a second interval which is shorter than the first interval, and irradiating the dots formed on the medium with electromagnetic waves.

With the printing method, even when dots are formed with high density, it is possible to suppress the spreading of ink.

According to the above aspect of the invention, there is provided the printing method that further includes irradiating the dots formed on the medium with electromagnetic waves in a second, a fourth, a sixth and a eighth process; in which the dots by the cyan ink, the magenta ink, and the yellow ink are formed in a first and a third process; the dots by at least any ink among the red ink, the green ink, the blue ink, and the orange ink are formed in a fifth and a seventh process; the dots formed in the first process are in a predetermined direction at a first interval; the dots formed in the third process are in the predetermined direction at the first interval so that the dots formed in the first process and the dots formed in the third process are positioned in the predetermined direction at a second interval which is shorter than the first interval; the dots formed in the fifth process are in the predetermined direction at the first interval; and the dots formed in the seventh process are in the predetermined direction at the first interval so that the dots formed in the fifth process and the dots formed in the seventh process are positioned in the predetermined direction at the second interval.

With the printing method, even when dots are formed with high density, it is possible to suppress the spreading of ink.

According to the above aspect of the invention, there is provided the printing method, in which the dots formed in the first process are irradiated in the second process so that the ink on the dots can continue to expand but not mix other inks.

With the printing method, even when dots are formed with high density, it is possible to suppress the spreading of ink.

According to the above aspect of the invention, there is provided the printing method, in which the dots are discharged in the fifth process so that the ink discharged in the fifth process and the ink discharged in the first and the second process are mixed easily.

With the printing method, even when dots are formed with high density, it is possible to suppress the spreading of ink.

According to the above aspect of the invention, there is provided the printing method that further includes a ninth process, irradiating the dots formed on the medium with electromagnetic waves so that the dots formed on the medium are completely solidified.

With the printing method, even when dots are formed with high density, it is possible to suppress the spreading of ink.

According to another aspect of the invention, there is provided a printing apparatus printing a color image on a medium. The printing apparatus includes a discharging unit that discharges a liquid that is cured when electromagnetic waves are irradiated to a medium to form dots on the medium; an irradiation unit that irradiates the dots with electromagnetic waves; in which the discharging unit forms the dots on a medium by discharging cyan ink, magenta ink, and yellow ink cured when irradiated with electromagnetic waves, and then forms the dots on the medium by discharging at least any ink among red ink, green ink, blue ink, and orange ink cured when irradiated with electromagnetic waves.

In the following embodiments, description will be provided with a line printer (printer 1) as an example of a printing apparatus.

### First Embodiment

### Regarding the Configuration of the Printer

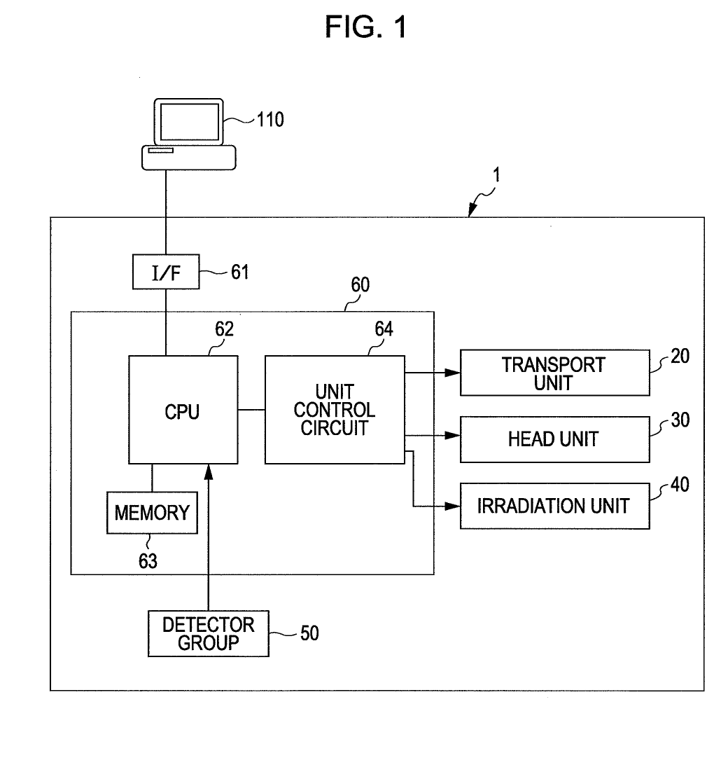

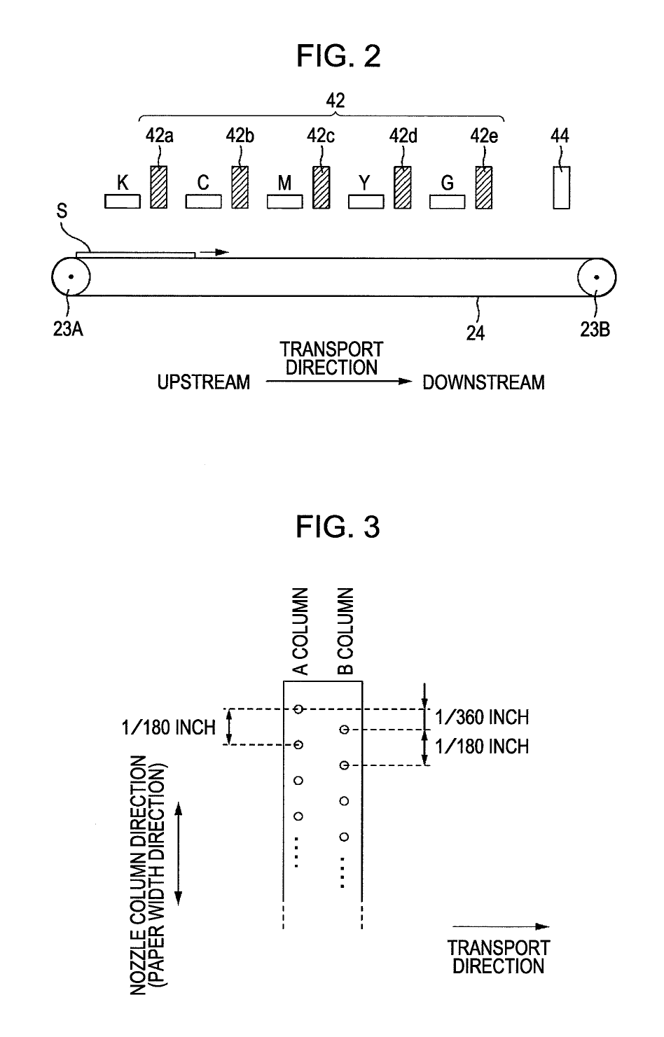

FIG. 1 is a block diagram illustrating the whole configuration of a printer 1. FIG. 2 is a schematic diagram illustrating the surroundings of a printing region.

The printer 1 is a printing apparatus that prints an image on a medium such as paper, fabric, film and the like, and is connected to a computer 110 which is an external apparatus so as to communicate therewith.

The computer 110 is installed with a printer driver. The printer driver displays a user interface on a display device (not shown in the drawing) and serves as a program that converts image data output from an application program into print data. The printer driver is recorded in a recording medium (a recording medium readable with a computer) such as a flexible disc (FD), CD-ROM, or the like. In addition, the printer driver can be downloaded in a computer 110 through the Internet. The program is composed of codes for realizing various functions.

In order to cause the printer 1 to print an image, the computer 110 outputs print data corresponding to the image to be printed to the printer 1.

A “printing apparatus” refers to an apparatus for printing an image onto a medium, for example, the printer 1. A “printing control apparatus” refers to an apparatus that controls the printing apparatus, for example, the computer 110 that is installed with the printer driver.

The printer 1 according to the present embodiment discharges ultraviolet-curable ink (hereinafter, referred to as UV ink) which is cured by being irradiated with ultraviolet light (hereinafter, referred to as UV light), as an example of liquid to print an image onto a medium. The UV ink includes ultraviolet-curable resin, and is cured by a photopolymerization reaction occurring in the ultraviolet-curable resin when irradiated with UV light. Furthermore, the printer 1 according to the present embodiment prints an image by using 5 colors of UV ink (color ink) including cyan, magenta, yellow, black, and green.

The printer 1 according to the present embodiment includes a transport unit 20, a head unit 30, an irradiation unit 40, a detector group 50, and a controller 60. The printer 1 that received print data from the computer 110 that is an external apparatus causes the controller 60 to control each unit (the transport unit 20, the head unit 30, and the irradiation unit 40) and prints an image on a medium according to the print data. The controller 60 controls each unit to print the image on the medium based on the print data received from the computer 110. The detector group 50 monitors the state in the printer 1. Furthermore, the detector group 50 outputs detected results to the controller 60. The controller 60 controls each unit based on the detected results output from the detector group 50.

The transport unit 20 functions to transport the medium (for example, paper and the like) in a predetermined direction (hereinafter, referred to as a transport direction). The transport unit 20 includes an upstream-side transport roller 23A, a downstream-side transport roller 23B, and a belt 24. When a transport motor (not shown in the drawing) rotates, the upstream-side transport roller 23A and the downstream-side transport roller 23B rotate, and thereby the belt 24 rotates. The medium fed by a feeding roller (not shown in the drawing) is transported to a printable region (a region opposed to heads) by the belt 24. As the belt 24 transports the medium, the medium is moved in the transport direction with respect to the head unit 30. The medium that passed through the printable region is discharged to the outside by the belt 24. In addition, the belt 24 applies electrostatic adsorption or vacuum adsorption to the medium during transportation.

The head unit 30 functions to discharge UV ink onto a medium. As UV ink in the present embodiment, 5 colors of UV ink including cyan, magenta, yellow, black, and green are used for forming an image. The head unit 30 discharges ink of each color onto the medium being transported to form dots and print an image on the medium. In the present embodiment, as shown in FIG. 2, a black ink head K for discharging UV ink of black color, a cyan ink head C for discharging UV ink of cyan color, a magenta ink head M for discharging UV ink of magenta color, a yellow ink head Y for discharging UV ink of yellow color, and a green ink head G for discharging UV ink of green color are provided in this order from the upstream side in the transport direction. The printer 1 in the present embodiment is a line printer, and each head in the head unit 30 can form as many dots as the width amount of the medium at one time.

The irradiation unit 40 irradiates the UV ink landed on the medium with UV light. The dots formed on the medium are irradiated with UV light output from the irradiation unit 40 and thereby cured. The irradiation unit 40 in the present embodiment is provided with an irradiation section for preliminary curing 42 and an irradiation section for permanent curing 44, and performs 2 steps of curing (UV irradiation), which are preliminary curing and permanent curing for the dots formed on the medium.

The irradiation section for preliminary curing 42 illuminates UV light for preliminary curing the dots formed on the medium. Furthermore, in the present embodiment, the preliminary curing refers to curing for preventing the spreading of ink between dots. However, ink continues to expand even after the preliminary curing. The printer 1 according to a second embodiment includes a first irradiation part 42a, a second irradiation part 42b, a third irradiation part 42c, a fourth irradiation part 42d, and a fifth irradiation part 42e in the irradiation section for preliminary curing 42.

The first irradiation part 42a is provided in the downstream side of the black ink head K in the transport direction, and the second irradiation part 42b is provided in the downstream side of the cyan ink head C in the transport direction. The third irradiation part 42c is provided in the downstream side of the magenta ink head M in the transport direction and the fourth irradiation part 42d is provided in the downstream side of the yellow ink head Y in the transport direction. The fifth irradiation part 42e is provided in the downstream side of the green ink head G in the transport direction.

The length of all the irradiation parts in the medium width direction is more than the width of the medium. Therefore, all the irradiation parts irradiate dots formed by all the heads in the head unit 30 with UV light.

Each irradiation part of the irradiation section for preliminary curing 42 in the present embodiment is provided with light emitting diodes (LEDs) as the light source of the UV irradiation. By controlling the magnitude of current input to the LEDs, it is possible to easily change irradiation energy of the LEDs.

The irradiation section for permanent curing 44 irradiates dots formed on the medium with UV light for permanent curing. In the present embodiment, the permanent curing refers to curing performed to completely solidify dots. In other words, the irradiation amount in the permanent curing is larger than that in the preliminary curing.

The irradiation section for permanent curing 44 is provided in the downstream side of the fifth irradiation part 42e of the irradiation section for preliminary curing 42 in the transport direction. The length of the irradiation section for permanent curing 44 in the medium width direction is more than the width of the medium. In addition, the irradiation section for permanent curing 44 irradiates the dots formed by each of the heads in the head unit 30 with UV light.

The irradiation section for permanent curing 44 in the present embodiment is provided with a lamp (a metal halide lamp, a mercury lamp, and the like) as a light source of the UV irradiation.

The detector group 50 includes a rotary encoder (not shown in the drawing), a paper detecting sensor (not shown in the drawing), and the like. The rotary encoder detects the rotation amount of upstream-side transport roller 23A and the downstream-side transport roller 23B. The transport amount of the medium can be detected based on the detected result of the rotary encoder. The paper detecting sensor detects the position of a leading end of the medium during feeding thereof.

The controller 60 is a control unit (control section) for controlling the printer. The controller 60 includes an interface section 61, a CPU 62, a memory 63, and a unit control circuit 64. The interface section 61 performs transmission and reception of data between the printer 1 and the computer 110 that is an external apparatus. The CPU 62 is an arithmetic processing unit for controlling the whole of the printer. The memory 63 functions to obtain a region for storing a program or a working region of the CPU 62, and includes memory elements such as RAM, EEPROM, or the like. The CPU 62 controls each unit via the unit control circuit 64 according to the program stored in the memory 63.

### Regarding Print Operation

When the printer 1 receives print data from the computer 110, the controller 60 causes the transport unit 20 to rotate feeding rollers (not shown) to feed the medium to be printed on the belt 24. The medium is transported on the belt 24 at a constant speed without stopping, and passes under the head unit 30, and the irradiation unit 40. During that time, the controller 60 causes the head unit 30 to intermittently discharge ink from nozzles of each head to form dots on the medium, and causes each irradiation section in the irradiation unit 40 to irradiate the dots with UV light. Accordingly, an image is printed on the medium. Furthermore, the controller 60 discharges the medium completed with the printing of the image.

### Regarding Arrangement of Nozzles in Each Head

FIG. 3 is an explanatory diagram illustrating the arrangement of nozzles in each head. Each head includes 2 nozzle columns of “A column” and “B column” as shown in the drawing.

Nozzles in each column are lined up at an interval of 1/180 inches (a nozzle pitch) along the direction (a nozzle column direction) that intersects with the transport direction. Moreover, the position of the nozzles in the A column in the nozzle column direction deviates from the position of the nozzles in the B column in the nozzle column direction by half a nozzle pitch ( 1/360 inches). Accordingly, it is possible to form dots of each color with a resolution of 1/360 inches.

### Regarding Ink

The printer uses “subtractive color mixing” to express various colors. Primary colors in the subtractive color mixing are 3 colors, which are cyan (C), magenta (M), and yellow (Y). Cyan (C) absorbs red (R), and reflects green (G) and blue (B). Magenta (M) absorbs green (G) and reflects red (R) and blue (B). Yellow (Y) absorbs blue (B) and reflects red (R) and green (G). That is, a visually recognizable image can be expressed with cyan ink, magenta ink, and yellow ink by adjusting the absorption amount of the 3 primary colors RGB of light. Hereinafter, cyan ink, magenta ink, and yellow ink are also referred to as C ink, M ink, and Y ink, respectively.

The printer 1 uses black ink (also referred to as K ink) and green ink (also referred to as G ink) in addition to CMY ink. The reason for using K ink is that dark black (deep black) cannot be expressed even by mixing 3 colors of CMY ink.

The reason for using G ink is based on the following.

In a landscape picture, for example, it is important to express the vivid green of trees. When expressing green color only with CMY ink, C ink and Y ink have to be mixed. However, if the 2 kinds of ink, C ink and Y ink, are mixed, the resulting color is often turbid. For that reason, the saturation of green is lowered and vivid green cannot be expressed. In the present embodiment, G ink that can solely express green color is prepared.

As such, G ink has a wider color expression range than CMY primary colors, and particularly, can have a color expression range with higher saturation.

UV ink has a characteristic of being cured when irradiated with UV light.

In addition, UV ink is required to have a sufficient adhering property in order to be used in printing on a medium (such as film) with low absorbability of ink. For that reason, oil-based ink is used as the UV ink. Oil-based ink does not mix easily. UV ink does not mix easily either because it is cured in a short period of time after being used in forming dots on a medium. For those reasons, dots formed first are covered by dots formed later, so that the dots formed later show better color development.

Since G ink aims to express high saturation as described above, it is more advantageous for color development when G ink is used later than when CMYK ink is used. In the printer 1 of the present embodiment, dots in G color can be formed last because the head for G ink is provided in the furthest downstream side of the transport direction. Therefore, it is possible to express green with higher saturation.

### Regarding Print Operation

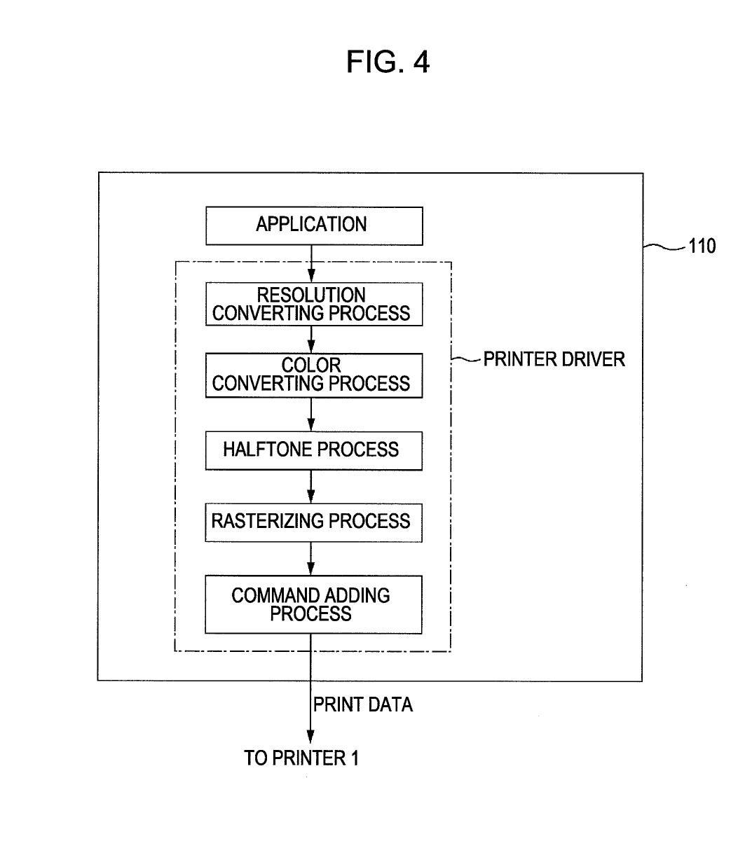

FIG. 4 is a flowchart illustrating a process performed by the printer driver during the printing of the printer 1.

The printer driver receives image data from an application program, converts the data into print data in a format that the printer 1 can interpret, and outputs the print data to the printer. When the image from the application program data is converted into the print data, the printer driver performs a resolution converting process, a color converting process, a halftone process, a rasterizing process, a command adding process, and the like. Hereinafter, various processes performed by the printer driver will be described.

The resolution converting process is a process for converting the image data (such as text data, and picture data) output from the application program so as to have the resolution (print resolution) adequate for printing on paper. For example, when the print resolution is designated with 720×720 dpi, the image data in a vector format received from the application program is converted into image data in a bitmap format with the resolution of 720×720 dpi. Furthermore, each pixel data of the image data after the resolution converting process is RGB data with multiple gray scales (for example, 256 gray scales) represented by RGB color space.

The color converting process is a process for converting the RGB data into data in CMYKG color space resulting from the addition of G plane to CMYK color space. Image data in CMYKG color space are data corresponding to colors of ink included in a printer. In other words, the printer driver generates image data of the CMYKG plane based on the RGB data.

The color converting process is performed based on a table (color conversion lookup table (LUT)) that matches the gray scale of RGB data with the gray scale of CMYKG data. The pixel data after the color converting process are the CMYKG data with 256 gray scales represented by the CMYKG color space.

The halftone process is a process for converting data with high gray scales into data with gray scales adequate for a printer to produce an image. For example, the halftone process can convert data representing 256 gray scales into 1 bit data representing 2 gray scales and 2 bit data representing 4 gray scales. In the halftone process, the dither method, the γ correction, the error diffusion method, and the like are used. Data subjected to the halftone process have the same resolution as the print resolution (for example, 720×720 dpi). In the image data subjected to the halftone process, each pixel corresponds to 1 bit or 2 bit pixel data, and then the pixel data become data representing the formation conditions of dots (such as the existence of dots, and the magnitude of dots) in each pixel. Furthermore, the image data of G plane among the image data in CMYKG color space after the halftone process are data showing the formation conditions of green dots in each pixel.

The rasterizing process rearranges pixel data that are arranged in a matrix form in each pixel data in the order of data to be transferred to the printer 1. For example, the pixel data are rearranged according to the arranging order of nozzles in each nozzle column.

The command adding process is a process for adding command data corresponding to a print method to data subjected to the rasterizing process. Examples of the command data include transport data representing the speed of transporting a medium, and the like.

Print data generated through such processes are transmitted to the printer 1 by the printer driver.

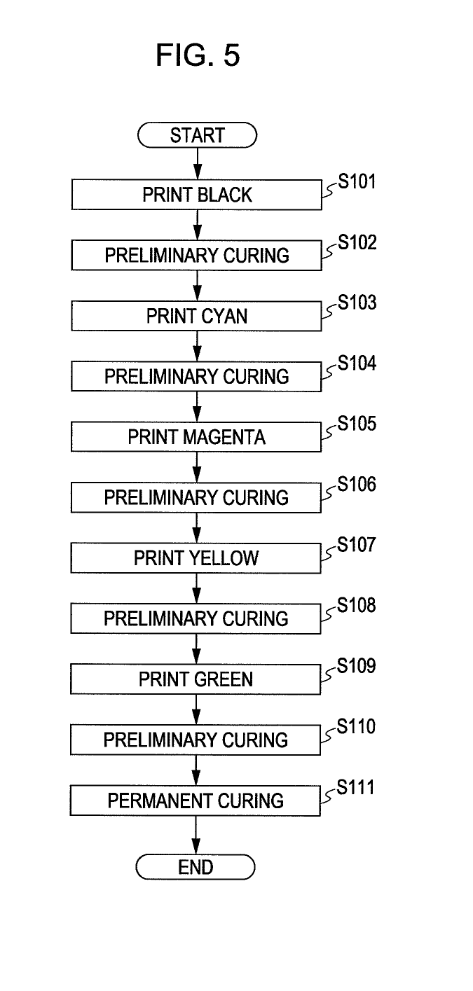

FIG. 5 is a flowchart illustrating a printing process performed by the printer 1.

First, the controller 60 causes the black ink head K to discharge K ink based on the print data during the transport of the medium to print black (S101). After the printing, the controller causes the first irradiation part 42a of the irradiation section for preliminary curing 42 to illuminate UV light to preliminarily cure the dots formed with the K ink (S102).

Next, the controller 60 causes the cyan ink head C to discharge C ink to print cyan (S103). After the printing, the controller causes the second irradiation part 42b to illuminate UV light to preliminarily cure the dots formed with the C ink (S104).

In the same manner, the controller 60 causes the magenta ink head M to discharge M ink to print magenta (S105), and causes the third irradiation part 42c to illuminate UV light to preliminarily cure the dots formed with the M ink (S106). Furthermore, the controller 60 causes the yellow ink head Y to discharge Y ink to print yellow (S107), and causes the fourth irradiation part 42d to illuminate UV light to preliminarily cure the dots formed with the Y ink (S108).

After that, the controller 60 causes the green ink head G to discharge G ink to print green (S109). In the present embodiment as above, since the dots of each CMYK color are preliminarily cured and then green is printed (the formation of dots), the G ink becomes hard to mix with each CMYK color in comparison with the case where green is printed before the dots of CMYK colors are preliminarily cured. Therefore, it is possible to express green with higher saturation.

Subsequently, the controller 60 causes the fifth irradiation part 42e to illuminate UV light to preliminarily cure the dots formed with G ink (S110).

Finally, the controller 60 causes the irradiation section for permanent curing 44 to illuminate UV light to permanently cure dots on the medium (S111).

After the permanent curing is performed, the medium is discharged.

### Summarization of the First Embodiment

In the present embodiment, after dots are formed on a medium by using UV ink of CMYK colors, green dots are formed by using G ink, and a color image is formed on the medium. Accordingly, since green dots are formed last, the green color can attain better color development.

Moreover, in the present embodiment, after dots are formed on the medium by using CMYK ink, preliminary curing is performed for the ink. Then, green is printed. Accordingly, the green ink does not mix easily with each ink of CMYK colors. Therefore, it is possible to improve the saturation of the green color.

### Second Embodiment

### Regarding the Configuration of the Printer

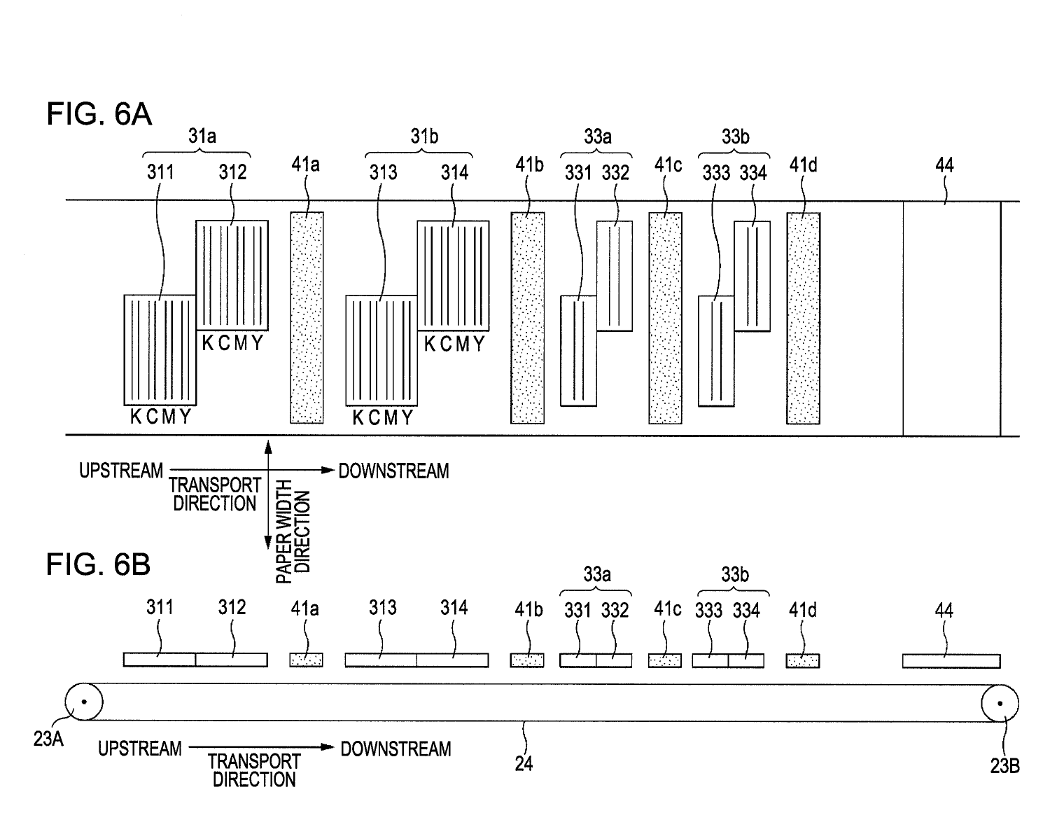

FIG. 6A is a schematic diagram illustrating a configuration of the surroundings of a printing region according to a second embodiment, and FIG. 6B is a diagram when FIG. 6A is viewed from a side. The printer of the second embodiment will be described with reference to FIGS. 1, 6A, and 6B. In addition, the same constituent parts in the second embodiment as those in the first embodiment are given the same reference numerals, and description thereof will not be repeated.

The printer 1 in the second embodiment includes a upstream-side color head group 31a, a downstream-side color head group 31b, a upstream-side green head group 33a, and a downstream-side green head group 33b as the head unit 30 in the order from the upstream side of the transport direction.

Hereinafter, the configuration of each head group of the head unit 30 will be described in detail.

The irradiation unit 40 in the second embodiment includes an irradiation section for preliminary curing 41 and an irradiation section for permanent curing 44.

The irradiation section for preliminary curing 41 irradiates dots formed on medium with UV light in order to preliminarily cure the dots. In the present embodiment, preliminary curing refers to curing performed for preventing ink from spreading between dots. However, the ink continues to expand even after the preliminary curing. The printer 1 in the second embodiment includes a first irradiation part 41a, a second irradiation part 41b, a third irradiation part 41c, and a fourth irradiation part 41d as the irradiation section for preliminary curing 41. In addition, in the present embodiment, light emitting diodes (LEDs) are used as the light source of UV irradiation from each irradiation section. By controlling the magnitude of current input to the LEDs, it is possible to easily change the irradiation energy of the LEDs.

The first irradiation part 41a is provided between the upstream-side color head group 31a and the downstream-side color head group 31b, and the second irradiation part 41b is provided between the downstream-side color head group 31b and the upstream-side green head group 33a. In addition, the third irradiation part 41c is provided between the upstream-side green head group 33a and the downstream-side green head group 33b, and the fourth irradiation part 41d is provided in the downstream side of the downstream-side green head group 33b in the transport direction.

The irradiation section for permanent curing 44 irradiates dots formed on a medium with UV light in order to permanently cure the dots. In the present embodiment, the permanent curing refers to curing performed to completely solidify dots. In other words, the irradiation amount in the permanent curing is larger than that in the preliminary curing.

The irradiation section for permanent curing 44 is provided in the downstream side of the fourth irradiation part 41d of the irradiation section for preliminary curing 41 in the transport direction. In addition, the length of the irradiation section for permanent curing 44 in the medium width direction is more than the width of the medium. Furthermore, the irradiation section for permanent curing 44 irradiates the dots formed by each head in the head unit 30 with UV light.

The irradiation section for permanent curing 44 according to the present embodiment is provided with a lamp (a metal halide lamp, a mercury lamp, and the like) as a light source of the UV irradiation.

### Regarding Print Operation

While the medium is transported in the transport direction, UV ink is discharged from the upstream-side color head group 31a and dots of CMYK colors are formed on the medium at an interval of 1/360 inches in the paper width direction. The dots formed by the upstream-side color head group 31a are irradiated with UV light from the first irradiation part 41a and then preliminarily cured. Furthermore, while the medium is transported, the UV ink is discharged from the downstream-side color head group 31b, and dots of CMYK colors are formed at the interval of 1/360 inches between dots formed by the upstream-side color head group 31a in the paper width direction. In other words, the dots are formed at an interval of 1/720 inches in the paper width direction. The dots formed by the downstream-side color head group 31b are irradiated with UV light from the second irradiation part 41b and preliminarily cured.

After that, while the medium is transported in the transport direction, the G ink is discharged from the upstream-side green head group 33a and dots of green color are formed on the medium at the interval of 1/360 inches in the paper width direction. The dots formed by the upstream-side green head group 33a are irradiated with UV light from the third irradiation part 41c and then preliminarily cured. Furthermore, the G ink is discharged from the downstream-side green head group 33b, and dots of green color are formed at the interval of 1/360 inches between the dots formed by the upstream-side green head group 33a. The dots formed by the downstream-side green head group 33b are irradiated with UV light from the fourth irradiation part 41d and preliminarily cured. In addition, the dots formed on the medium are irradiated with UV light from the irradiation section for permanent curing 44 and permanently cured. As above, an image is printed on the medium.

### Regarding the Head Unit

Next, the configuration of the head unit 30 shown in FIGS. 6A and 6B will be described.

The head unit 30 of the present embodiment includes the upstream-side color head group 31a, the downstream-side color head group 31b, the upstream-side green head group 33a, and the downstream-side green head group 33b as described above.

The upstream-side color head group 31a discharges each CMYK ink in order to print an image. The upstream-side color head group 31a according to the present embodiment forms dots with 360 dpi in the paper width direction. The formation conditions of the dots will be described later.

The upstream-side color head group 31a includes a first color head 311 and a second color head 312. In the present embodiment, the number of heads in the upstream-side color head group 31a is assumed to be 2 for the sake of simple explanation, but may be more. Each color head includes 8 nozzle columns. In other words, each color head includes 2 nozzle columns for each of the 4 colors (CMYK). The arrangement of nozzles will be described later.

The first color head 311 is provided in the lower side in FIG. 6A, and the second color head 312 is provided in the upper side in FIG. 6A. In other words, the first color head 311 and the second color head 312 form dots in different regions on the medium. In addition, the positions of the first color head 311 and the second color head 312 in the paper width direction partially overlap each other.

The arrangement of nozzles in the first color head 311 and the second color head 312 will be described later.

The downstream-side color head group 31b also discharges each CMYK ink in order to print an image. The downstream-side color head group 31b according to the present embodiment forms dots with 360 dpi in the paper width direction. The downstream-side color head group 31b forms dots so as to position the dots between the dots formed by the upstream-side color head group 31a (between the dots in the paper width direction). The formation conditions of the dots will be described later.

The downstream-side color head group 31b has substantially the same configuration as the upstream-side color head group 31a, and includes a third color head 313 and a fourth color head 314. In the downstream-side color head group 31b, the third color head 313 is positioned in the lower side in FIG. 6A and the fourth color head 314 is positioned in the upper side in FIG. 6A. However, the downstream-side color head group 31b is deviated from the upstream-side color head group 31a by 1/720 inches in the paper width direction.

The upstream-side green head group 33a discharges G ink. The upstream-side green head group 33a in the present embodiment forms dots with 360 dpi in the paper width direction.

The upstream-side green head group 33a includes a first green head 331 and a second green head 332. The first green head 331 is positioned in the lower side in FIG. 6A and the second green head 332 is positioned in the upper side in FIG. 6A. For example, the position of the first green head 331 is the same as that of the first color head 311 in the paper width direction, and the position of the second green head 332 is the same as that of the second color head 312 in the paper width direction.

The downstream-side green head group 33b discharges the G ink. The downstream-side green head group 33b according to the present embodiment forms dots with 360 dpi in the paper width direction. Moreover, the downstream-side green head group 33b forms dots so as to position the dots between the dots formed by the upstream-side green head group 33a (between the dots in the paper width direction. The formation conditions of the dots will be described later.

The downstream-side green head group 33b includes a third green head 333 and a fourth green head 334. The third green head 333 is positioned in the lower side in FIG. 6A and the fourth green head 334 is positioned in the upper side in FIG. 6A. For example, the position of the third green head 333 is the same as that of the third color head 313 in the paper width direction, and the position of the fourth green head 334 is the same as that of the fourth color head 314 in the paper width direction.

### Regarding the Arrangement of Nozzles in Each Head and the Formation of Dots

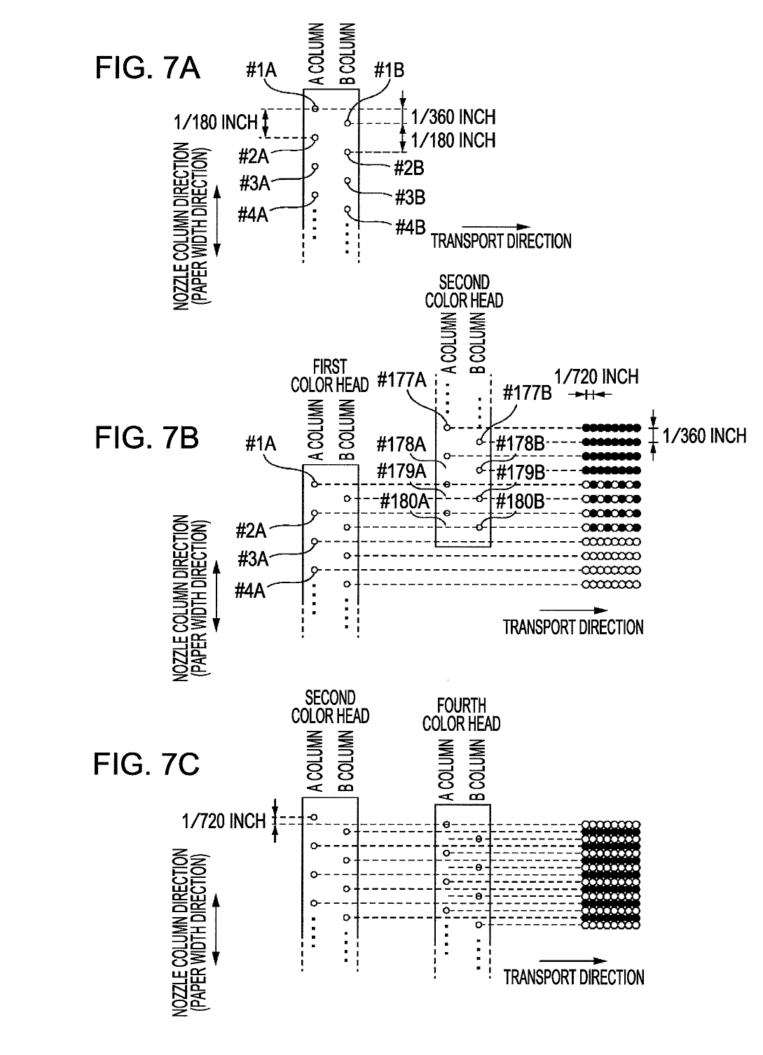

FIGS. 7A to 7C are diagrams for explaining the arrangement of nozzles in each head and the formation of dots.

FIG. 7A is an explanatory diagram illustrating the arrangement of nozzles in 2 nozzle columns for black color in the first color head 311. The 2 nozzle columns for black color in the first color head 311 will be described, but the same description applies to the 2 nozzle columns for black color in other color heads and black in nozzle columns for other colors. In addition, the nozzle columns in each green head (the first green head 331 to the fourth green head 334) have the same configuration as in FIG. 7A.

Each head is provided with 2 nozzle columns for black color, which are A column and B column. Each of the nozzle columns has 180 nozzles. For each of the nozzles, numbers such as #1, #2, #3 . . . are given from the top of the drawing. Each nozzle number for nozzles in the A column is attached with the suffix “A” at the end of the number, and each nozzle number for nozzles in the B column is attached with the suffix “B” at the end of the number.

Nozzles in each column are arranged at the interval of 1/180 inches (nozzle pitch) along the direction (a nozzle column direction) that intersects with the transport direction. Furthermore, as shown in FIG. 7A, the position of nozzles in the A column in the nozzle column direction is deviated from the position of nozzles in the B column in the nozzle column direction by half a nozzle pitch ( 1/360 inches). For example, with respect to the nozzle column direction (paper width direction), nozzle #1 of the B column is positioned between nozzle #1 and nozzle #2 of the A column. Accordingly, the nozzles for black color in each color head are arranged by half a nozzle pitch of 1/360 inches in the nozzle column direction (paper width direction). Therefore, it is possible to form color dots with the resolution of 1/360 inches (360 dpi). The same is applied to each head for other colors.

Left side of FIG. 7B shows the positional relationship between nozzles for black color of 2 color heads (the first color head 311 and the second color head 312) in the upstream-side color head group 31a. In addition, the positional relationship between nozzles for black color in the upstream-side color head group 31a will be described, but the same description applies to the black color of 2 color heads (the third color head 313 and the fourth color head 314) in the downstream-side color head group 31b. The description for black color applies to other colors in the same manner, and to the positional relationship between the first green head 331 and the second green head 332, and the positional relationship between the third green head 333 and the fourth green head 334.

As shown in FIG. 7B, the position of the first color head 311 and the second color head 312 partially overlap each other in the nozzle column direction (paper width direction).

For example, 2 nozzles (#1A and #2A) in the A column of the first color head 311 in the upper side of the drawing and 2 nozzles (#179A and #180A) in the A column of the second color head 312 in the lower side of the drawing are in the same position (overlapping position) in the nozzle column direction (paper width direction). 2 nozzles (#1B and #2B) in the B column of the first color head 311 in the upper side of the drawing and 2 nozzles (#179B and #180B) in the B column of the second color head 312 in the lower side of the drawing are in the same position (overlapping position) in the nozzle column direction (paper width direction). As above, the nozzles in the overlapping positions in the nozzle column direction are referred to as overlapping nozzles. In addition, nozzles other than the overlapping nozzles are referred to as normal nozzles.

The right side of FIG. 7B shows the formation of dots for black color by the upstream-side color head group 31a (each head in the left side of FIG. 7B). White circles in the drawing represent dots formed by the nozzles in the first color head 311, and black circles in the drawing represent dots formed by the nozzles in the second color head 312.

Regarding the Formation of Dots by Nozzles that do not Overlap

The normal nozzles (nozzles other than the overlapping nozzles) discharge ink every time the medium is transported by 1/720 inches. Accordingly, dots are formed at the interval of 1/720 inches in the transport direction. In the case where the positions of each head do not overlap, one dot row (a row of dots arranged in the transport direction) is formed by one nozzle. For example, the dot row in the uppermost line shown in FIG. 7B is formed by the nozzle #177A in the second color head 312, and the dot row in the lowest line is formed by the nozzle #4B in the first color head 311. Accordingly, each dot row is arranged at the interval of 1/360 inches in the nozzle column direction (paper width direction).

### Regarding the Formation of Dots by Overlapping Nozzles

The overlapping nozzles form half dots in comparison to the normal nozzles. For example, as shown in FIG. 7B the nozzle #1A in the first color head 311 forms dots at every other dot (at the interval of 1/360 inches) in the transport direction.

Overlapping nozzles in one head form dots between dots formed by overlapping nozzle in the other head (within the transport direction). For example, the nozzle #179A in the second color head 312 forms dots between dots formed by the nozzle #1A in the first color head 311 at every other dot (at the interval of 1/360 inches) in the transport direction. As above, 2 overlapping nozzles form one dot row. In other words, the 2 overlapping nozzles accomplish the same function as 1 normal nozzle.

As above, 1 head group forms dots at the interval of 1/360 inches in the paper width direction.

The left side of FIG. 7C shows the positional relationship between nozzles for black color in the upstream-side color head group 31a and the downstream-side color head group 31b. The positional relationship between nozzles for black color in the second color head 312 and the fourth color head 314 will be described below, but the same description will be applied to black color in the first color head 311 and the third color head 313. In addition, the same description is applied to other colors, and to the positional relationship between the second green head 332 and the fourth green head 334, and the positional relationship between the first green head and the third green head.

As shown in FIG. 7C, the position of nozzles for black color in the second color head 312 (the upstream-side color head group 31a) in the nozzle column direction is deviated from the position of nozzles for black color in the fourth color head 314 (the downstream-side color head group 31b) in the nozzle column direction by ¼ nozzle pitch ( 1/720 inches).

The right side of FIG. 7C shows the formation of dots of black color by the second color head 312 and the fourth color head 314.

Black circles in the drawing represent dots formed by the nozzle for black color in the second color head 312. The formation of dots of the black circles is the same as that in the right side of FIG. 7B.

White circles in FIG. 7C represent dots formed by the nozzle for black color in the fourth color head 314. As shown in the drawing, the nozzles in the fourth color head 314 form dots between the dots formed by the nozzles in the second color head 312 at the interval of 1/360 inches in the paper width direction. For example, the nozzle #1A in the fourth color head 314 forms a dot row between 2 dot rows respectively formed by the nozzles #1A and #1B in the second color head 312. Accordingly, it is possible to form dots for black color with the resolution of 1/720 inches (720 dpi).

### Regarding Print Operation according to the Second Embodiment

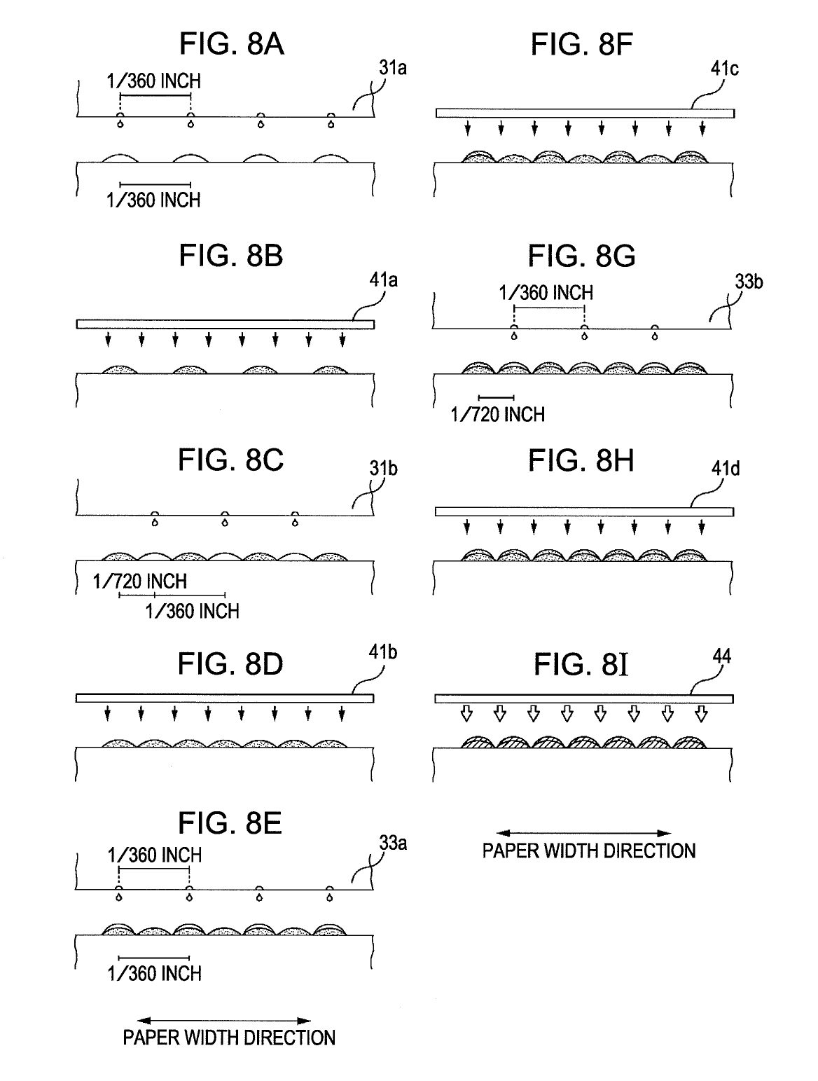

FIGS. 8A to 8I are explanatory diagrams illustrating the appearance of dots being formed according to the second embodiment.

As the medium is transported in the transport direction, the medium first passes under the upstream-side color head group 31a. At this point, the controller 60 causes the upstream-side color head group 31a to discharge ink. Accordingly, dots are formed on the medium at the interval of 1/360 inches in the paper width direction, as shown in FIG. 8A.

The medium formed with the dots by the upstream-side color head group 31a then passes under the first irradiation part 41a. The controller 60 causes the first irradiation part 41a to illuminate UV light as shown in FIG. 8B in order to preliminarily cure the dots formed by the upstream-side color head group 31a. Furthermore, the preliminary curing suppresses the spreading of ink between the dots, but the ink continues to expand.

Subsequently, the medium is transported in the transport direction and passes under the downstream-side color head group 31b. The controller 60 causes the downstream-side color head group 31b to discharge ink from the nozzles thereof. As shown in FIG. 8C (and FIG. 7C), the downstream-side color head group 31b forms dots (dot rows) at the interval of 1/360 inches between the dots (dot rows) formed by the upstream-side color head group 31a. Accordingly, the medium is printed with dots formed at the interval of 1/720 inches in the paper width direction. In addition, the dots are formed between the dots that have been preliminarily cured. Therefore, the spreading of ink seldom occurs even though the dots adjacent to other dots come into contact each other as shown in the drawing.

The medium printed with the dots formed by the downstream-side color head group 31b then passes under the second irradiation part 41b. The controller 60 causes the second irradiation part 41b to illuminate UV light as shown in FIG. 8D in order to preliminarily cure the dots formed by the downstream-side color head group 31b. The preliminary curing suppresses the spreading of ink between dots, but the ink (dots) continues to expand.

Thereafter, the medium passes under the upstream-side green head group 33a. At this point, the controller 60 causes the upstream-side green head group 33a to discharge ink. Accordingly, as shown in FIG. 8E, dots of green color are formed on the medium at the interval of 1/360 inches in the paper width direction. In the present embodiment, since dots in green ink are formed after the dots in CMYK ink are preliminarily cured, the green ink does not easily mix with the CMYK ink.

The medium printed with dots formed by the upstream-side green head group 33a then passes under the third irradiation part 41c. The controller 60 causes the third irradiation part 41c to illuminate UV light as shown in FIG. 8F in order to preliminarily cure the dots formed by the upstream-side green head group 33a. The preliminary curing suppresses the spreading of ink between dots, but the ink continues to expand.

Subsequently, the medium is transported in the transport direction, and passes under the downstream-side green head group 33b. The controller 60 causes the downstream-side green head group 33b to discharge ink from the nozzles thereof. As shown in FIG. 8G (and FIG. 7C), the downstream-side green head group 33b forms dots (dot rows) at the interval of 1/360 inches between the dots (dot rows) formed by the upstream-side green head group 33a. Accordingly, dots of green color are formed on the medium at the interval of 1/720 inches in the paper width direction. In addition, the dots are formed between the dots that have been preliminarily cured. Therefore, the spreading of ink seldom occurs even though the dots adjacent to other dots come into contact each other as shown in the drawing.

The medium printed with dots formed by the downstream-side green head group 33b then passes under the fourth irradiation part 41d. The controller 60 causes the fourth irradiation part 41d to illuminate UV light as shown in FIG. 8H in order to preliminarily cure the dots formed by the downstream-side green head group 33b. The preliminary curing suppresses the spreading of ink between dots, but the ink (dots) continues to expand.

As shown in FIG. 8I, finally, when the medium passes under the irradiation section for permanent curing 44, the controller 60 causes the irradiation section for permanent curing 44 to illuminate UV light for permanent curing, and thereby the dots formed on the medium are completely solidified.

### Summarization of the Second Embodiment

In the second embodiment, after the dots are formed on the medium by using the UV ink of CMYK, dots are formed by using green ink, and thereby a color image is formed on the medium. Accordingly, since green dots are formed last, it is possible to improve the green color development.

Furthermore, in the second embodiment, the preliminary curing is performed after the dots are formed on the medium by using the cyan ink, the magenta ink, and the yellow ink. After that, green is printed. Accordingly, the green ink does not easily mix with the cyan ink, the magenta ink, and the yellow ink. Therefore, it is possible to improve the saturation of green.

In addition, in the second embodiment, after the upstream-side green head group 33a forms the dots at the interval of 1/360 inches, the third irradiation part 41c preliminarily cures the dots. Then, the downstream-side green head group 33b forms dots at the interval of 1/360 inches between the dots formed by the upstream-side green head group 33a. In other words, the dots of green color are formed at the interval of 1/720 inches. As above, even when dots of green color are formed with high density, the spreading of ink can be suppressed.

### Other Embodiments

The printer has been described as one embodiment, but the embodiment above is provided in order to help understanding of the invention, and the embodiments are not limited thereto. The invention can be changed or modified with the scope not departing from the gist of the invention, and at the same time, the invention includes any equivalents thereof. Particularly, the embodiments to be described below are included in the invention.

### Regarding Printers

In the embodiments described above, a printer has been explained as an example of a printing apparatus, but the printing apparatus is not limited thereto. For example, the same technology as the present embodiments may be put to practical use for various printing apparatuses to which ink jet technology is applied, such as a color filter manufacturing apparatus, a dyeing apparatus, a micro-fabricated device, semiconductor manufacturing equipment, a surface treatment device, a three-dimensional modeling device, a vaporizer, an organic EL manufacturing apparatus (particularly, a polymer EL manufacturing apparatus), a display manufacturing apparatus, coating equipment, a DNA chip manufacturing apparatus, and the like.

### Regarding Ink-1

The G ink has been used as ink other than CMYK in the embodiments described above, but the ink is not limited thereto. Red (R) ink, blue (B) ink, and orange (Or) ink may be used instead of the G ink.

For example, in a landscape picture, it is important to express the vivid red or orange color of the sunset. In this case, the use of R ink or Or ink makes it possible to express the vivid red or orange color.

Furthermore, in a landscape picture, it is important to express the vivid blue of the sky. In this case, the use of B ink makes it possible to express the vivid blue.

In short, at least any ink among red, green blue, and orange may be used.

Such ink has a wider color expression range than the CMY primary color ink, particularly, a color expression range with higher saturation, as described above, which, however, is not limited to the 4 colors above, and any ink that has a wider color expression range than the CMY primary color inks, particularly, a color expression range with higher saturation, may be employed.

Moreover, it may be possible to provide a plurality of heads that discharge the ink having an expanded color expression range. For example, in the case of FIG. 2, a pair of the green ink heads G for G ink and the fifth irradiation part 42e in the irradiation section for preliminary curing in the downstream side of the green ink head G in the transport direction may be provided in plural in the downstream side of the transport direction in order to match one ink with one pair. In addition, in the case of FIG. 6, a pair of the head groups 33a and 33b for G ink and the third and fourth irradiation part 41c and 41d in the irradiation section for preliminary curing may be provided in plural in order to match one ink with one pair in the same manner as in FIG. 2.

Furthermore, as a head for discharging the ink having a color expression range as above, a head provided with a plurality of nozzle columns corresponding to plural kinds of ink in one head to discharge the plural kinds of ink may be employed. In this case, after dots are formed on a medium by using the plural kinds of ink having an expanded color expression range, the dots may be cured with the irradiation of electromagnetic waves together. By forming dots as above at least after forming dots with CMY primary color ink, it is possible to obtain better color expression than with the CMY primary color ink, and color expression with higher saturation.

### Regarding Ink-2

After the formation of dots in ink of each color, there may be further provided a head for discharging colorless and transparent clear ink in the downstream side of heads for each color in the transport direction to discharge the clear ink onto a medium. Furthermore, it is not limited to the clear ink, and it is possible to discharge ink for a background, such as white ink, in order to paint the background of an image.

### Regarding Ink-3

In the embodiments described above, the ink (UV ink) cured by the irradiation of ultraviolet (UV) light is discharged from the nozzles. However, the liquid discharged from the nozzles is not limited to the ink cured by UV light and any ink affected by electromagnetic waves may be employed. For example, ink cured by visible light may be used. In this case, each irradiation section illuminates visible light (electromagnetic waves) having a wavelength adequate for curing the ink.

### Regarding Printer Driver

The process of the printer driver in FIG. 4 may be performed in the printer. In this case, a printing apparatus may be constituted with a PC installed with a printer and a printer driver.

### Regarding Preliminary Curing

In the embodiments described above, before discharging G ink, preliminary curing is performed for the dots formed with each ink of the CMYK colors, but the preliminary curing may not be performed. In this case, a little spreading of ink between dots of each color may occur. In the present embodiment, however, since green dots are formed later than dots of other colors (there is no chance of being covered by dots of other colors), it is possible to improve the green color development.

The entire disclosure of Japanese Patent Application No. 2009-030321, filed Feb. 12, 2009 is expressly incorporated by reference herein.

What is claimed is:

1. A printing method of printing a color image on a medium using a printing apparatus, the method comprising:
forming dots on a medium by using cyan ink, magenta ink, and yellow ink that are cured when irradiated with electromagnetic waves; and
then forming dots on the medium by using at least any ink among red ink, green ink, blue ink, and orange ink that are cured when irradiated with electromagnetic waves.

2. The printing method according to claim 1,
wherein the dots formed with the cyan ink, the magenta ink, and the yellow ink are irradiated with the electromagnetic waves, after forming the dots on the medium by using the cyan ink, the magenta ink, and the yellow ink, and before forming the dots on the medium by using at least any ink among the red ink, the green ink, the blue ink, and the orange ink.

3. The printing method according to claim 1, further comprising:
forming dots on the medium at a first interval in a predetermined direction by discharging at least any predetermined ink among the red ink, the green ink, the blue ink, and the orange ink on the medium;
irradiating the dots formed on the medium with electromagnetic waves;
forming dots on the medium at the first interval in the predetermined direction with the predetermined ink so that the dots irradiated with electromagnetic waves and the dots not irradiated with electromagnetic waves are positioned in the predetermined direction at a second interval which is shorter than the first interval; and
irradiating the dots formed on the medium with electromagnetic waves.

4. A printing apparatus printing a color image on a medium, the apparatus comprising:
a discharging unit that discharges a liquid that is cured when electromagnetic waves are irradiated to a medium to form dots on the medium;
an irradiation unit that irradiates the dots with electromagnetic waves;
wherein the discharging unit forms the dots on a medium by discharging cyan ink, magenta ink, and yellow ink that are cured when irradiated with electromagnetic waves, and then forms the dots on the medium by discharging at least any ink among red ink, green ink, blue ink, and orange ink that are cured when irradiated with electromagnetic waves.

5. The printing method according to claim 1, further comprising:
irradiating the dots formed on the medium with electromagnetic waves in a second, a fourth, a sixth and a eighth process;
wherein the dots by the cyan ink, the magenta ink, and the yellow ink are formed in a first and a third process;
the dots by at least any ink among the red ink, the green ink, the blue ink, and the orange ink are formed in a fifth and a seventh process;
the dots formed in the first process are in a predetermined direction at a first interval;
the dots formed in the third process are in the predetermined direction at the first interval so that the dots formed in the first process and the dots formed in the third process are positioned in the predetermined direction at a second interval which is shorter than the first interval;
the dots formed in the fifth process are in the predetermined direction at the first interval; and
the dots formed in the seventh process are in the predetermined direction at the first interval so that the dots formed in the fifth process and the dots formed in the seventh process are positioned in the predetermined direction at the second interval.

6. The printing method according to claim 5, wherein,
the dots formed in the first process are irradiated in the second process so that the ink on the dots can continue to expand but not mix other inks.

7. The printing method according to claim 6, wherein,
the dots are discharged in the fifth process so that the ink discharged in the fifth process and the ink discharged in the first and the second process are mixed easily.

8. The printing method according to claim 7, further comprising:
a ninth process, irradiating the dots formed on the medium with electromagnetic waves so that the dots formed on the medium are completely solidified.

9. The printing apparatus according to claim 4, wherein,
the discharging unit forms the dots by the cyan ink, the magenta ink, and the yellow ink are formed in a first and a third process, and the dots by at least any ink among the red ink, the green ink, the blue ink, and the orange ink are formed in a fifth and a seventh process;
the irradiation unit irradiates the dots formed on the medium with electromagnetic waves in a second, a fourth, a sixth and a eighth process;
the dots formed in the first process are in a predetermined direction at a first interval;
the dots formed in the third process are in the predetermined direction at the first interval so that the dots formed in the first process and the dots formed in the third process are positioned in the predetermined direction at a second interval which is shorter than the first interval;
the dots formed in the fifth process are in the predetermined direction at the first interval; and
the dots formed in the seventh process are in the predetermined direction at the first interval so that the dots formed in the fifth process and the dots formed in the seventh process are positioned in the predetermined direction at the second interval.

10. The printing apparatus according to claim 9, wherein,
the dots formed in the first process are irradiated in the second process so that the ink on the dots can continue to expand but not mix other inks.

11. The printing apparatus according to claim 10, wherein,
the dots are discharged in the fifth process so that the ink discharged in the fifth process and the ink discharged in the first and the second process are mixed easily.

12. The printing apparatus according to claim 11, wherein,
the irradiation unit irradiates the dots formed on the medium with electromagnetic waves in a ninth process so that the dots formed on the medium are completely solidified.
